(19) United States
(12) Patent Application Publication
(10) Pub. No.: US 2025/0045665 A1
(43) Pub. Date: Feb. 6, 2025

(54) FOOD CONTAMINANT ASSESSMENT

(71) Applicant: SOCIETE DES PRODUITS NESTLE S.A., Vevey (CH)

(72) Inventors: TILL STEPHANE GOLDMANN, Rivaz (CH); MAXIM BOBKOV, Epalinges (CH)

(21) Appl. No.: 18/717,209

(22) PCT Filed: Dec. 8, 2022
(86) PCT No.: PCT/EP2022/084923

§ 371 Date: Jun. 6, 2024

(30) Foreign Application Priority Data
Dec. 8, 2021 (EP) 21213142.9

(51) Int. Cl. G06Q 10/0635

(52) U.S. Cl. CPC G06Q 10/0635

(57) ABSTRACT

The invention concerns a computer-implemented method for predicting risks associated with the presence of contaminants in a food. The method can comprise receiving a query defining a food, a geography and a contaminant. The method can then determine a risk that the food contains the contaminant in relation to the geography. The method also comprises providing a response to the query comprising one or more recommended management actions in relation to the determined risk.

### FIELD AND BACKGROUND

The present disclosure relates to a method and system for assessment of contaminants in foods and in particular but not exclusively to a method and a computer-based system for assessing the risk of contaminants being linked to food-related issues, and for proposing appropriate management actions in relation to such contaminants.

The presence of contaminants, such as pesticides or veterinary drugs, in processed food, is a risk that is well-known by the food industry.

In this disclosure the term “food” is to be understood as corresponding to any single or multiple materials, whether processed, semi-processed or raw, which is intended for human consumption, such as according to the definition from the Codex Alimentarius (FAO and WHO. 2019. Codex Alimentarius Commission—Procedural Manual twenty-seventh edition. Rome. ISBN 978-92-5-131099-1): “Food means any substance, whether processed, semi-processed or raw, which is intended for human consumption, and includes drink, chewing gum and any substance which has been used in the manufacture, preparation or treatment of “food” but does not include cosmetics or tobacco or substances used only as drugs.”

Examples of food include:
a) food from plant origin such as but not limited to raw or processed fruits, vegetables, herbs, spices. Examples of food from plant origin are fresh basil, apple puree, food colorant E160b derived from annato, virgin olive oil, natural smoke aroma, lecithins.
b) food from animal origin such as but not limited to meat, eggs, dairy products, honey, whey powder, tuna, egg yolk.
c) food from mineral such as but not limited to calcium carbonate, sodium chloride salt.
d) food produced with chemical, biological or modern technologies such as but not limited food colorant E133, artificial flavours, enzymes, lactic acid bacteria, baking soda, modified starches with increased jellifying properties, genetically modified salmon.

Thus, as discussed herein “food” includes both stand-alone foods (whether single-ingredient foods or foods prepared from multiple ingredients) and also ingredients intended to be combined to produce a multi-ingredient food, such as in accordance with a food preparation recipe.

In this disclosure, the “feed” is to be understood as corresponding to products, single or multiple materials, whether processed, semi-processed or raw, which is intended to be fed directly to animal such as according to the definition from the Codex Alimentarius Standard (CXC 54-2004; Code of Practice on Good Animal Feeding). Thus it will be understood that feed may be treated as equivalent to food in the sense that every technique and/or constraint described herein as applicable to food may also be applied to feed.

In this disclosure the term “contaminants” is to be understood as corresponding to substances that may be found in food or feed in a manner that one or more persons or authorities may consider undesirable. Thus, “contaminants” as used herein includes:
(i) Any substance not intentionally added to food or feed for food producing animals, which is present in such food or feed as a result of the production (including operations carried out in crop husbandry, animal husbandry and veterinary medicine), manufacture, processing, preparation, treatment, packing, packaging, transport or holding of such food or feed, or as a result of environmental contamination. In this regard, the CODEX-General Standard for Contaminants and Toxins in Food and Feed may also be relevant: “Contaminant means any substance not intentionally added to food, which is present in such food as a result of the production (including operations carried out in crop husbandry, animal husbandry and veterinary medicine), manufacture, processing, preparation, treatment, packing, packaging, transport or holding of such food or as a result of environmental contamination. The term does not include insect fragments, rodent hairs and other extraneous matter.”
(ii) Any substance, intentionally and legitimately added to food or feed, that still may trigger food-related issues due to not following recommended practices or due to incidents occurred during food production (such as but not limited to the over-supplementation of an approved vitamin) or to mis-alignment of the regulatory framework between producing and marketing country (such as but not limited to food additives authorised in one country but banned in the country where the food containing them will ultimately be marketed).
(iii) Any substances, intentionally but illegitimately added to food or feed, such as but not limited to adulterants.

Example of contaminants include:
a) substances used to support plant- and animal-derived food production, or derived from such use such as but not limited to plant protection products, fertilizers, veterinary drugs and their metabolites and degradation products;
b) substances naturally occurring in the environment such as but not limited to mycotoxins, plant toxins, chemical elements (such as but not limited to heavy metals);
c) substances occurring in the environment resulting from anthropogenic activities or from technogenic catastrophes such as but not limited to persistent organic pollutants, pollutants resulting from incineration, radionuclides;
d) substances entering the food or feed chain through direct or indirect contact:
   with any contaminated surfaces or production equipment during production, transportation and storage such as but not limited to biocides, mould contamination of pallets, lubricants;
   with packaging, such as but not limited to mineral oils from jute bags, plasticizers, semi-carbazide in gaskets;
   or through fumigation procedures such as but not limited to food sterilization by ethylene oxide;
e) substances generated during food or feed processing especial during heat treatment, frying, drying or fermentation such as but not limited to Maillard Reaction products, acrylamide, carbamates, furans, nitrosamines, chloropropanediol and its fatty acid esters, glycidol and its fatty acid esters;
f) substances legitimately or illegitimately added to food which may trigger food-related issues such as but not limited to food additives, food processing aids, food adulterants;
g) micro-organisms, such as but not limited to viruses and bacteria, that may enter the food chain at any step or resulting from not following respective recommended practices during food production;
h) traces originating from food derived from specific technologies, such as but not limited to biotechnology or nanotechnology, and differing from their conventional counterpart, such as but not limited to genetically modified crops, titanium oxide used as nanoparticle state.

Such contaminants can therefore originate from a wide variety of sources along the food preparation chain. Indeed, through that food preparation chain, it is possible for food to become contaminated with multiple contaminants. Moreover, where multiple foods are used as ingredients for a multi-ingredient good, each of those ingredients may contain a number of such contaminants. Thus it is possible for both single-ingredient foods and foods prepared from multiple ingredients to ultimately contain contaminant amounts that exceed the authorized quantities in a market where said foods are sold, or otherwise to exceed safe quantities or otherwise cause a food-related issue.

As will be understood, food (whether single-ingredient foods or foods prepared from multiple ingredients) is subject to strict quality assessments, by both manufacturer and independent laboratories. Such assessments aim to ensure that foods meet suitable food quality levels. It will be understood that food quality may relate to any one or more of food safety, food taste, food texture, food compliance or the like. Where the presence of a contaminant in a food may give rise to a drop in any such food quality measure, this can be described as a food-related issue. Thus, such quality assessments may aim to ensure that such contaminants do not impact the quality of a food.

Despite the use of food quality assessments throughout the food production chain, risks still exist that a contaminant may potentially remain at a higher level than desired, at the time a food reaches a consumer. This can be due for instance to regulatory changes in a given country, new scientific discoveries that reveal new risks associated with a compound that was previously considered safe, or the like.

Thus it is seen that there is significant challenge for the food industry in maintaining quality (e.g. including safety) of food products. The operation of complex food supply chain channels leads to complex food quality solutions in order to minimize risks (both to businesses involved in the food industry, and to consumers of foods) and ultimately avoid product recalls which currently occur at a rate thousands per year globally. Taking only the European Union, it is understood that the number of food recalls that took place in 2020 was over 3400. The direct consequences of these recalls include food waste and associated costs impacting both the food industry and the consumers.

Some methods and systems (such as the “Checkyourscope” system provided by an EU reference laboratory, see: https://www.eurl-pesticides.eu/docs/public/tmplt_article.asp?LabID=200&CntID=746&Lang=EN) have been developed which provide a general ranking of pesticides allowing to prioritize them in terms of integration in an analytical portfolio to be targeted in laboratories. This Excel-based system, based on allocation of points based upon toxicology, residue situation in crops and agricultural usage, however provides only a recommendation that a given pesticide is included to a laboratory analytical portfolio.

### SUMMARY

The present invention concerns a computer-implemented method, a system for predicting risks of contaminants presence in a food or feed, and a related readable medium, per claim 1 and following.

Especially, it relates to a computer-implemented method for predicting and managing risks associated with the presence of contaminants in a food or feed product, the method comprising:
i) providing at least one ingredient present in said food or feed product from a user query, and at least one marketing country for the product,
ii) obtaining a geographic origin for said at least one ingredient,
iii) calculating a risk score that the food or feed contains a contaminant in relation to said ingredient present in the food or feed product and their respective geographical origin, said calculation being based on the combination of at least one query data selected within the list of: type of contaminant, type of food or feed, type of geography, with at least one input data selected within the list of contaminant intrinsic relevance, contaminant likelihood to be used or to be found in the food environment, contaminant maximum residue level, contaminant maximum limits status, analytical data, contaminant derived properties,
and
iv) providing a response to the query comprising one or more specified management actions in relation to the determined risk score, as follows:
   if the score corresponds to no risk identified, the management action corresponds to an authorization to integrate the ingredient in the food or feed product, or
   if the score corresponds to a risk identified that requires the ingredient not to be used, the management action corresponds to a recommendation to take at least one action within the following choices:
a) source the ingredient from a different supplier,
b) conduct further detection tests to verify the presence or absence of the identified contaminant in a specific ingredient batch,
c) modify the ingredient and/or food or feed product production process to eliminate the identified contaminant,
d) reject the ingredient from the food or feed ingredients list.

The presently disclosed approaches provide a method and system which is able to predict risks associated to a wide variety of contaminants in foods and/or feeds, and propose appropriate management actions in relation to such contaminants. Such approaches may take into account various parameters that can impact a quality assessment of a given food or feed.

The present approaches therefore provide an integrated food/feed quality system solution that allows in-silico assessment of the risk of contaminants' occurrence to be linked to food/feed-related issues and outputting of proposals for appropriate management actions. Thus an in-silico analysis for contaminant presence/risk can be conducted before or during food/feed production chain stages such as commissioning of food/feed production, food/feed production, food/feed harvest or food/feed transportation, and therefore any risk management/mitigation actions that need to be employed can be instituted before food/feed is prepared for sale and in some cases before food/feed is transported and/or grown.

Viewed from a first perspective, there can be provided a method for predicting risks associated with the presence of contaminants in a food or feed product, the method comprising: receiving a query defining a food or feed product, a geography and a contaminant; determining a risk that the food or feed product contains the contaminant in relation to the geography; and providing a response to the query comprising one or more specified management actions in relation to the determined risk.

Viewed from another perspective, there can be provided a system for predicting risks associated with the presence of contaminants in a food or feed product, the system comprising a programmable computer unit configured to receive a query defining a food or feed product, a geography and a contaminant; determine a risk that the food or feed product contains the contaminant in relation to the geography; and provide a response to the query comprising one or more specified management actions in relation to the determined risk.

The present teachings may be provided by way of a computer readable medium carrying instruction for executing such a method and/or programming a computer as such as system.

### BRIEF DESCRIPTION OF THE DRAWINGS

Example implementations of the presently taught approaches will now be described with reference to the following drawings in which:

FIG. 1 is a schematic illustration of an example system for deploying the present approaches;

FIG. 2 is a schematic illustration of a data definition structure for query dimension data definitions as may be used with the present approaches;

FIG. 3 is a schematic illustration of a process flow for the present approaches;

FIG. 4 is a schematic illustration of a high level decision tree that may be used in the present approaches;

FIG. 5 is a schematic illustration of a data definition structure for output action definitions as may be used with the present approaches; and

FIG. 6 is a schematic illustration of management action proposals decision chart.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

The present approaches are concerned with analysing one or more large and non-homogenous data sets against a query set in three or more dimensions. To facilitate such analysis for a result that will permit specific mitigation actions to be deployed, the data sets are defined and may be characterised according to properties of the data, and query and/or the data sets are subjected to content processing that provides for the query to be evaluated against relevant data from the data sets despite differing nomenclature, format and/or language of the data in the data sets as compared to the query definition.

In the following discussion, the terms food and feed will be used interchangeably, and it will therefore be understood that all references to food may be substituted for references to feed unless stated otherwise or the context indicates otherwise.

More specifically, the present approaches permit the evaluation of a query that specifies a contaminant, a food in which there is concern that the contaminant might appear, and a geography from which the food may originate and/or in which the food is intended to be used/consumed/processed/sold (for brevity all of these uses are generally referred to herein as used and/or consumed). Such a query is evaluated against the one or more large and non-homogenous data sets to determine a risk that the food may contain such a contaminant when sourced from and/or used/consumed in the specified geography. From such a determined risk, one or more responsive actions can be defined so as to permit management of that risk.

By utilising the present approaches there can be achieved an in-silico (computer-based) analysis that can be used to mitigate or minimise the risk (which may also or alternatively be referred to as a likelihood) of food product recalls and food crises by proactively maintaining a high level of quality and food safety compliance in the products sold to consumers. By adopting the present approaches, the prior limitations relating to forecasting the presence of contaminants that may trigger recalls/crises may be addressed. The present approaches may provide such outcomes by taking into account in a meaningful way existing complex and heterogeneous data sets relating to contaminants in food, such as the various individual and overlapping regulatory frameworks across a variety of countries/jurisdictions for control of contaminants, can also take into account potentially unknown origins of food, and thereby avoid food quality issues that could arise from sparse data or a total lack of data as to which contaminants may arise from the production of the food and/or which contaminants may be present in food of a particular type and/or origin, and/or from limited resources available for food production surveillance.

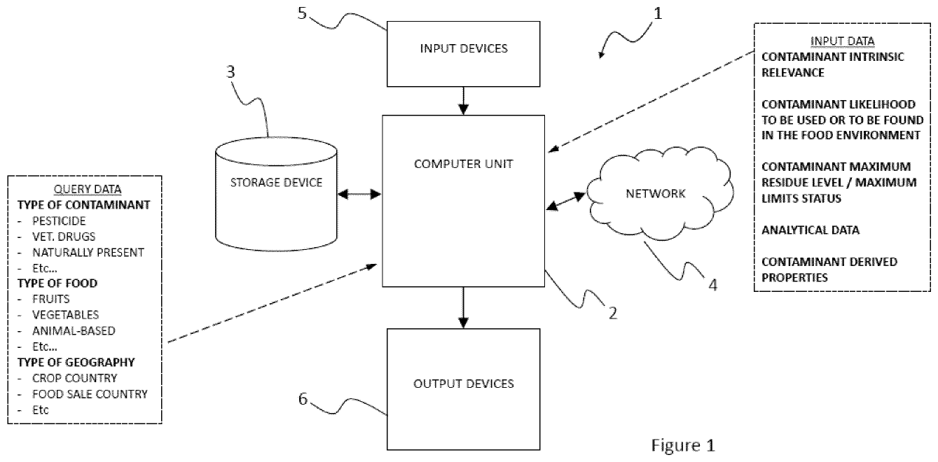

As shown in FIG. 1, a system 1 can be deployed for implementing the present approaches. In the system, a computer unit 2 is provided. In the present example this is a computer unit having a processor and memory configured to execute instructions that provide the functionality of the present approaches.

The computer unit 2 has or is connected to a storage device 3. The storage device 3 of the present example is a local storage device such as a magnetic hard disk or solid-stage drive, but in other examples may be any other data storage device whether local to the computer unit 2 or a remote storage such as a network addressable storage, storage area network or cloud storage. The storage device 3 may be used to store input query data including queries as to a contaminant, a food and a geography for which a risk is to be determined, as will be further described below. In some examples the storage device 3 may also store program instructions for the computer unit 2 to use in operation and/or may store input data to be used in evaluating query data.

The computer unit is also connected to a network 4. In order to communicate with such a network 4, the computer unit 2 may include one or more network communication interfaces. The network 4 provides access to remote data sources and/or inputs. Such remote data sources and/or inputs may include a source of a query specifying query data. Such remote data sources may also or alternatively include a source of input data which is used to evaluate the query data. In the present examples, the network 4 provides connectivity to one or more data stores from which the input data can be accessed or obtained by the computer unit 2, and thus examples of the network 4 include a LAN, WAN, the Internet, or the like over which the input data may be provided from a data store. To obtain data from a remote data store, the computer unit 2 may invoke a suitable API of the data store. The data retrieved from the data store may be some or all of an already-created data set and/or may be a real-time or near-real-time fetch of data from a dynamically updated data set. In other examples, the network contains the input data data store(s) and in such examples the network 4 may be a storage area network, cloud data service or the like. In addition, it will be understood that input data received via the network may be stored or cached within memory of the computer unit 2 and/or within the storage device 3.

The computer unit 2 is also provided with one or more input devices 5 by means of which a user may provide inputs to the system. Examples include buttons, a keyboard, a mouse or other pointing device, or the like. Other examples include a port into which a physical data medium may be inserted. Using the input devices 5 a user may cause initiation of a query evaluation. The query may be already stored in the storage device 3, may be input directly using the input devices 5, or may be received over the network 4.

The computer unit 2 is also provided with one or more output devices 6 by means of which the system may provide outputs to a user. Examples include a display, a printer, an audio output device, or the like. The output devices 6 are used by the system to provide feedback to a user on running of the system and in particular progress in handling a query. A display for example may be used to implement a graphical user interface in which the user can enter inputs using the input devices 5 and receive information from the display. An audio output device may communicate a user interface audibly, and/or may provide audible alerts such as to acknowledge an instruction and/or to indicate a query process is completed. In some examples, the output of the query processing, including any management action proposals, may be provided in a data file format, such as may be displayed via an output device, stored on a storage device and/or transmitted via the network. Such a data file may be formatted according to an intended software environment for a user to utilise the output of the query processing, such as a metadata-formatted flat file (such as to be used with a system such as SAP SCM or SRM software, for instance an XML file) or a database readable file (such as to be used with a database application such as SAP HANA, Oracle Database, MySQL or the like).

In addition, the input devices 5 and/or output devices 6 may be provided by way of a mobile device having its own input and output devices, which transfers inputs received at the mobile device to the computer unit, and transfers outputs from the computer unit to the mobile device for display/output thereat. Such a mobile device may communicate with the computer unit 2 via a wired or wireless connection, such as a PAN technology, LAN technology, WAN technology and/or an access network technology, for example.

Thus, in use the system may receive a query or selection of an existing query to resolve via the input devices, evaluate that query using the input data and the output the risk and/or an identified action to be taken in relation to such a risk. The output may be provided wholly or in part via the output devices, or may be communicated to another system using the network 4. As the query data and input data may variously be provided from the storage device 3, network 4 and/or input devices 5, the query data and input data are illustrated in FIG. 1 with dashed lines directly to the computer unit 2.

As will therefore be clear, in this example the system 1 is implemented in a single network-connected computer system. In other examples, the system may be implemented in a distributed computing environment with any user interface capabilities provided by some form of terminal device, the terminal device having either local software interfacing with the system in the distributed computing environment or accessing a web interface provided by one or more elements of the system in the distributed computing environment.

Thus it will be understood that the system 1 includes processing capability that can receive a query (e.g. from a direct user input, from a local storage, from a remote storage or from a remote system), receive input data usable to resolve the query (e.g. from a direct user input, from a local storage, from a remote storage or from a remote system) and process that query to provide an output comprising one or more of a risk that a certain contaminant will be present and an identified action to be taken in relation to such a risk. The query, input data, risk and identified actions will be discussed further below.

As FIG. 1 illustrates, the query data of the present examples relates to a type of contaminant, a type of food and a type of geography. Each of these elements or factors may be termed a dimension of the query.

Contaminants that the present approaches can evaluate in a query may include any one or more contaminants as defined above, including for example pesticides, veterinary drugs, toxic metals, biocides, mycotoxins, anthropogenic environmental contaminants, process contaminants, naturally occurring substances (such as minerals found in a food production geography), genetically modified organisms (GMO) or the like. As also noted above, contaminants may include derived terms such as active ingredient metabolites or complex regulatory residue definitions. Some further examples of contaminants that may be considered are Aldicarb sulfone, Bacillus thuringiensis, 1-Napthylacetamide and 1-napthylacetic acid (sum of 1-napthylacetamide and 1-napthylacetic acid and its salts, expressed as 1-napthylacetic acid). As explained above, all contaminants as considered herein are substances that may be harmful, potentially harmful or otherwise undesirable in food.

Types of food may include anyone or more foods as defined above, including foods used directly as single-ingredient foods and/or foods used as ingredients for multi-ingredient foods and/or multi-ingredient foods themselves. Further examples of foods may include plant material (such as fruits, vegetables, spices, herbs, plant oils or the like), animal-based (such as fish, meat, animal fats or the like), or mineral (such as mined minerals, manufactured colorants/flavourings or the like). Some examples of foods that may be considered are Cereals, Maize, Lemon juice concentrated 32 Brix. As explained above, all types of food as considered herein are intended to form or be used as ingredients for food.

Types of geography as considered herein include geographic and/or geopolitical divisions related to production, use and/or consumption of an edible food, drink or the like. Such geographic and/or geopolitical divisions may include continents, countries (e.g. nation states), sub-regions of countries (e.g. states, cantons, counties etc), and/or food production regions of any relevant size (e.g. the Nile delta, The Low Countries, a wine production appellation, a region associated with a particular registered designation of origin, etc). Some examples of geographies that may be considered are Worldwide, South-Europe and Brazil.

These query data are used to build a specific query relating to the risk of a certain contaminant (or contaminants) occurring in a given type of food from a given geography and/or to be used or consumed (e.g. sold) in a given geography. One illustrative query is the question: ‘is it likely that aldicarb (contaminants dimension) in association to lemons (food dimension) originating from Brazil (geographical dimension) may lead to issues when marketed in Germany (geographical dimension).

It should be noted that additional elements or factors (dimensions) may be included in a query, such as a food production scheme (e.g. organic, animal welfare standard, UTZ sustainable farming standard, Bio Suisse certified, etc). In addition, elements and/or factors (dimensions) such as those specific to a certain business or market may be taken into account. For example, compliance may vary depending on the field of use. For example, there may be different constraints for human adult nutrition product vs human infant nutrition products vs human geriatric nutrition products. Also, for example, there may be different constraints for animal feed for productive animals vs pets.

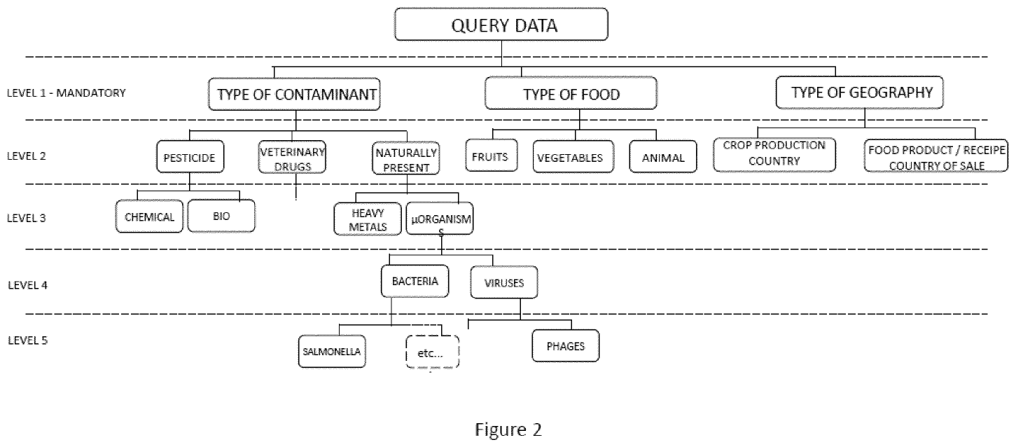

Turning to FIG. 2, there is illustrated a schematic data definition structure for query dimension data definitions as may be used with the present approaches. As is indicated, the present example considers the highest level of inputs for defining the query as mandatory, these being to define a type of contaminant, a type of food, and a type of geography.

As illustrated, the definition may optionally include one or more further levels of definition for the query. For example, in the type of contaminant the query may specify whether this is a pesticide, a veterinary drug or a naturally occurring substance. In the example of a naturally occurring substance, this may be specified as a heavy metal or a microorganism, and so on. Some of these further definitions may be provided by a user entering the query data, for example the user may specify whether an indicated geography is to be considered in the query as a food production geography or a food user/consumption geography. Some of the further definitions may be known to the system, for example if the user specified a contaminant “Cadmium” the system may already know and be able to populate the various levels that specify this contaminant as being “naturally present” and within “heavy metals”.

As FIG. 1 also illustrates, the input data of the present examples relates to a contaminant intrinsic relevance, a contaminant risk to be used or to be found in the food environment, a contaminant Maximum Residue Level/Maximum Limits status, an analytical data, and a contaminant derived properties. These elements or factors may be termed “decision support elements”. Each decision support element includes or relies upon several properties which allow characterisation of each decision support element, as is illustrated below.

Contaminant intrinsic relevance as used herein refers to a known or measured risk that substance defined as a contaminant is inherently relevant to one or more foods. In some implementations, this can be an indication as to whether the defined contaminant is actually considered a contaminant from the perspective that an action might need to be defined to manage the contaminant. In other words, the contaminant intrinsic relevance may be assessed at the level of the contaminant dimension of the query, as it may be considered as an intrinsic characteristic of the contaminant itself. For example, lecithins resulting from the use of plant protection products could be considered not to be relevant on the basis that they are already naturally occurring components of certain foods, such as vegetable oils. In another example, the substance Chlorpyrifos which is a well-defined insecticide known to result in residues in treated plants may be considered to have intrinsic relevance as a contaminant.

In addition to being taken into consideration in relation to the contaminant dimension of the query, the contaminant intrinsic relevance may also or alternatively be considered in the context of other ones of the query dimensions. For instance, the criteria set to define the intrinsic relevance of the contaminant may be country-specific (or otherwise geography-specific) or may be related to another query dimension such as business/industry. One example could be a micro-organism used as bio-pesticide that perhaps has no intrinsic relevance in a food production geography (e.g. where its use is permitted and no monitoring is required) whereas in another geography (e.g. an intended food consumption geography) that same micro-organism may be considered as a risk, thus having an intrinsic relevance as a contaminant. In implementations where GMO are considered as contaminants, this geography dimension may be very relevant as controls on GMO are an example of a potential contaminant that is presently very much country specific.

Another example related to the food dimension is that a contaminant may be considered inherently relevant to production of baked goods utilising cereals, but that same contaminant is not considered inherently relevant for production of foods in the form of distilled alcohols as the contaminant is destroyed, removed or denatured by the alcohol distillation process. Further such examples include that subjecting a food to a heat process may remove some microbiological contaminant risks and/or may degrade some antinutrient compound contaminants. A more specific example is that processing coffee using certain enzymes can reduce the presence of acrylamides (contaminant) in the coffee.

Thus the contaminant intrinsic relevance may for example be characterised by properties such as the food and/or geography to which the relevance applies, an age/up-to-date property of the relevance data or the like.

Contaminant occurrence risk of being used or being found in the food environment as used herein refers to a risk of having a given contaminant being associated to a food and/or a geographic origin resulting from the production (including operations carried out in crop husbandry, animal husbandry and veterinary medicine), manufacture, processing, preparation, treatment, packing, packaging, transport or holding of such food or as a result of environmental contamination. This occurrence risk information can be provided from sources such as registration of a certain contaminant for use in food production in a given geography, and/or from scientific literature or research relating to presence of substances in a given location, and/or from observations/discussion relevant to the field. For instance, Acetamiprid being registered in Switzerland for use on apples may be used as a marker of this contaminant being likely to be used or found in the food environment. In another example scientific publications reporting on a natural presence of Cadmium in Honduras may be used as a marker of risk of this contaminant being likely to be used or found in the food environment. As will be appreciated, this decision support element is perhaps in some instances more tied to a food origin geography than a food use or consumption geography, but may be relevant to all of the food, geography and contaminant dimensions of the query. Thus the contaminant occurrence risk of being used or being found in the food environment may be characterised by various properties such as the food dimension, the geography dimension, the nature of the data source, the age of the information, the quantity of relevant data, the diversity of the origin data, etc.

Contaminant Maximum Residue Level/Maximum Limits status as used herein refers to regulatory information on maximum permissible limits and/or reside levels of the contaminant. This decision support element is applicable to the geography dimension in that such regulatory information is likely to be set on a geopolitical level (such as by country). This may be relevant to the food production geography as regulation on the presence of a certain contaminant may be a marker that the contaminant is in use in the food production environment. This may also or alternatively be relevant to the food use/consumption geography as regulation on residues/limits permissible in food for consumption may be expected to apply in relation to sale/supply of food within such a geography. In addition, this decision support element may be applicable to the food dimension as the regulatory information may relate to specific foods in which the contaminant is considered to be of concern from a regulatory perspective. However, the present approaches may also take account of this decision support element without reference to the food dimension, or in relation to a genericised/abstracted definition of the food dimension. For example, if a regulation exists for residue in pears, the decision support element may be considered for a wider range of foods, such as pears and apples, all tree-grown fruits, all fruits, all plant-based foods, etc. For instance a regulation specifying that Carbaryl is regulated in Canada with a limit of 7 mg/kg may be taken as a marker that Carbaryl is likely to occur in blueberries, with possible additional considerations that this likely occurrence may apply to blueberries sold in Canada, blueberries from Canada, shrub-gown fruit including blueberries, and/or all fruits. As will be understood, the absence of a regulatory limit may be considered as a specific usable data for this decision support element, as a lack of regulation may be indicative as to a low risk of contaminant presence and/or a low relevance of a contaminant. Likewise, a remediation specified for a regulatory breach may be indicative of the severity of the contaminant as a contaminant. Thus the contaminant maximum residue level/maximum limits may be characterized based on properties such as the geography to which the regulatory limit applies, the food to which the regulatory limit applies, the regulatory penalty for breaching the limit, the regulatory remediation required for breaching the limit, etc.

Analytical data as used herein refers to the existence (or absence) and content of any analytical data relating to one or more of the query dimensions and any associated attributes/metadata, such as the quantity of data, the number of findings of a particular result in the data, any limits on the data (such as quantization limits) and associated statistics. As will be understood, the absence of any analytical data may be considered as a specific usable data for this decision support element. Examples may include data that: no analytical data are available for Carbaryl in blueberries from Canada; 1000 data are available for glyphosate, 30 data collected over a 5-year period are above 0.005 mg/kg for chlorpyriphos on conventional fresh peppers from Turkey, etc. As these examples illustrate, the analytical data may relate to the contaminant, and/or may relate to other dimensions in additional to the contaminant dimension. As an example, analytical data may be characterized by several properties such as the name of the analyte, the food tested, the concentration, the year of the analysis as well as associated statistics. Thus when using the analytical data in evaluation of the query, each of these characterisations may be taken into account, e.g. specifying that only data from the most recent n years is to be used, or specifying that in order to be relevant the analyte must be detectable at a certain minimum concentration.

Contaminant derived properties as used herein refer to the allocation of contaminants to specific lists sets by external or internal bodies deriving from any or all of the other decision support elements. Again, the absence of any contaminant derived properties may be considered as a specific usable data for this decision support element. For example, if a given pesticide or other plant protection product is not included in any contaminant derived properties related to critical, acute or long term toxicity for a given geography (such as a geopolitical region covered by such an internal or external body) then the risk of that contaminant as causing an issue if found in food may be seen as inherently low (or lower than for a pesticide known or suspected to have critical, acute or long term toxicity—such as a pesticide identified a possible carcinogen). For instance, a listing may define that Alicarb is an unacceptable pesticide according to the 4C certification standard for coffee. Many other such food standards organisations exist and operate on differing geographic and/or food extents. Thus it will be understood that this decision support element relates to the contaminant dimension, and may or may not also relate to the food dimension and the geography dimension. Accordingly, the contaminant derived properties may be characterised by properties such as a level of recognition of the body that listed the contaminant, the food for which the contaminant is listed, a geography in which the listing body operates, etc.

Illustrative examples of specific properties that may be used to characterise one or more of the decision support elements are shown in the following table 1:

TABLE 1
illustrative indication of example properties and their possible relation to the dimensions and decision support elements.

| | | | | | DECISION SUPPORT ELEMENTS, | | | | |
|---|---|---|---|---|---|---|---|---|---|
| | | | | | examples of relation | | | | |
| | | | | | | Contaminant | | | |
| | | | | | | risk to be | Contaminant | | |
| | | AXES (DIMENSIONS), | | | | used or to | Maximum | | |
| | | examples of relation | | | Contaminant | be found in | Residue | | Contaminant |
| | Example property | | Geog- | Contam- | intrinsic | the food | Level/ | Analytical | derived |
| Example property | value | Food | raphy | inant | relevance | environment | Maximum | data | properties |
| Contaminants term | Aldicarb sulfone | | | X | | | X | X | X |
| Contaminants | Aldicarb | | | X | X | X | X | X | X |
| common | | | | | | | | | |
| denominator | | | | | | | | | |
| Contaminants group | Aldicarb incl. | | | | | | X | X | |
| name | metabolites | | | | | | | | |
| Intrinsic relevance to | Relevant | | | X | X | | | | |
| be associated with | | | | | | | | | |
| management action | | | | | | | | | |
| Food | Grapefruits, fresh | X | | | | X | X | X | |
| Crop origin country | Mexico | | X | | | X | | X | |
| Food market country | Switzerland | | X | | | X | X | X | |
| MRLs in crop origin | Yes | X | X | X | | | | | |
| country suggests | | | | | | | | | |
| possible residues | | | | | | | | | |
| Availability of | Available | X | X | X | | | | X | |
| analytical data | | | | | | | | | |
| Number of analytical | 100 | X | X | X | | | | X | |
| data | | | | | | | | | |
| Number of positive | 20 | X | X | X | | | | X | |
| findings | | | | | | | | | |
| Analysis year | 2015-2020 | | | | | | | X | |
| Contaminants | TOX WHO 1A, GHS | | | | | | | | X |
| presence in | H330, Rotterdam | | | | | | | | |
| specific lists | PIC, PAN list 2021 | | | | | | | | |

Thus it will be understood that the present approaches can be implemented to address a significantly non-trivial situation of evaluating a query (in three or more dimensions) against a potentially enormous volume of non-homogenous data making up the decision support elements (for example many millions of data points). Each of the decision support elements may be of varying relevance to different queries, and each individual query is to be evaluated as completely and as accurately as possible against all of the available data for each of the decision support elements. Also, as will be further described below, in order to provide such complete and accurate evaluation of the query the present approaches may need to take into account decision support element data in a variety of different data formats, different languages and using different names or terms to describe the same or similar entities in each of the query dimensions. The characterisations of each of the decision support elements may also assist with the “big data” nature of the query evaluation process, as the characterisations can be defined such as to enable very disparate types of data in the decision support elements to be made comparable.

Thus the present approaches permit the evaluation of a query that specifies a contaminant, a food in which there is concern that the contaminant might appear, and a geography from which the food may originate and/or in which the food is intended to be used/consumed/processed/sold (for brevity all of these uses are generally referred to herein as used and/or consumed). Such a query is evaluated against the one or more large and non-homogenous data sets to determine a risk that the food may contain such a contaminant when sourced from and/or used/consumed in the specified geography. From such a determined risk, one or more responsive actions can be defined so as to permit management of that risk.

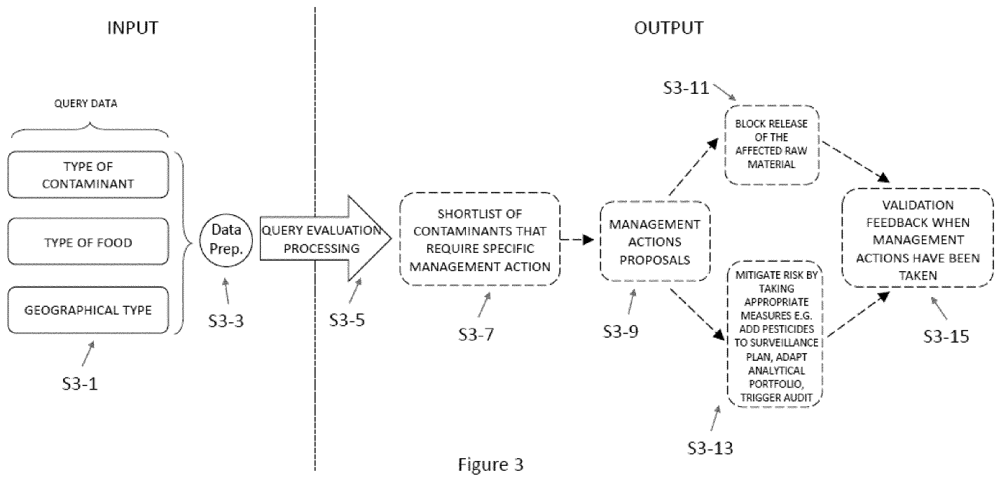

FIG. 3 illustrates a method of the present approaches to use the decision support elements to evaluate the query and provide a management proposal. All steps indicated in dashed lines may be considered optional in at least some implementations.

As illustrated in FIG. 3, the method of the present approaches uses these query data (identified at step S3-1) and if necessary prepares these query data for processing at step S3-3. Examples of pre-preparation include data format conversion, nomenclature processing (which may include synonym processing and/or closely-related-data processing), and language processing.

Data format conversion is used where the query is provided in a format that is not directly compatible with the processing steps which will be used to evaluate the query. One example would be where the query expresses an amount parameter in Imperial units whereas the processing of the query requires metric/SI units.

Synonym processing may include mapping a parameter specified in the query data (such as the name of the contaminant, food and/or geography) to possible synonyms of that data which may be used in the input data which will be used in evaluating the query. For example, the food specified in the query data may be “courgette” and the synonym processing would map this to “zucchini” and any other terms use to describe this food. In another example, the geography specified in the query data may be “The Low Countries” and the synonym processing could map this to “Belgium”, “The Netherlands” and “Luxembourg”.

Closely-related-data processing may include expanding the definitions in the query data to include items closely related to the specified definition. For example, in the definition of the contaminant the closely-related-data processing may add other closely related compounds, such as salts, esters, metabolites, degradation products, complex residue definitions for that contaminant. All of these additional contaminant definitions may be defined in addition in the query, or the query may be adapted to a generic level which would include all such closely-related compounds into the query evaluation processing. Such a generic level may be termed a common denominator. One specific example is that the contaminant defined in the query may be ‘Glyphosate sodium salt’ and ‘Glyphosate potassium salt’, whereas in the input data that will be used to evaluate the query these may be analytical data related to “Glyphosate” and “aminomethylphosphonic acid”, and input data relating to a contaminant Maximum Residue Level/Maximum Limits status could specify “N-(phosphonomethyl)glycine, including the metabolites aminomethylphosphonic acid, N-[(acetylamino)methyl]phosphonic acid and N-acetyl-N-(phosphonomethyl)glycine”. In this example the common denominator could be “Glyphosate”.

Closely-related data processing may also be performed on the food and/or geography definitions in the query data. For example, if the food is defined as “Blood orange”, the common denominator “Oranges” or “Citrus fruit” could be set so as to include other orange varieties such as “Seville Oranges” and “Satsumas”, and in the case of setting the common denominator as “Citrus fruit” to also include “Lemons”. Likewise, if the geography is set to an area such as a particular relatively small geographic area, the common denominator could be expanded to include surrounding areas. For example if the defined geography is “Norfolk, UK”, the common denominator may be set as “East Anglia, UK” so as to include nearby geographies with similar growing environments.

Language processing may include expanding the definitions in the query data to include the same definitions in multiple languages. The language processing may be linked to geographies specified in the query definition or may be applied more universally. For example, if the food of interest is grapefruit and the query is built by a German speaker, then the query might be expected to define “Grapefruit” as the food dimension. In this example, if the specified geography is for fruit imported to Switzerland from South America then the definition may be expanded to include the translation of this defined food into languages relevant to the food source geography (such as Spanish (pomelo) and Portuguese (Toranja)) and/or may be expanded to include the translation of this defined food into languages relevant to the food use/consumption geography (such as French (pamplemousse) and Italian (popelmo). Further translations may include other languages spoken in the source geography (continuing the same example these might include Quechua and Gaurani). Translation may also or alternatively be provided for the term(s) used to define the contaminant dimension and/or the term(s) used to define the geography dimension. As well as translations specific to the geographies specified in the query definition, the translations may also include languages associated with high volume scientific publication, and could for example be expanded so far as to include all languages known for use in definition of food regulation in any country. The languages may also or alternatively be limited by the scope of the data set making up the decision support elements against which the query will be evaluated, for example if all of the data is in English, French, German, Spanish, Italian, Japanese and Mandarin then there may be no need to translate beyond these languages even if the geographies involved might imply further languages.

It should be noted that any or all of these data preparation methods as described in relation to step S3-3 may instead or additionally be performed on the input data that makes up the decision support data that will be used to evaluate the query, and/or may be performed as part of the query evaluation processing. For example there could be a process performed on the input data of data extraction from various sources (databases, data files (e.g. Excel), reports (e.g. PDF) etc) to process that input data into the decision support data support by adapting the input data into a standardized language by way of defined conversions and/or mappings to enable the various input data to function as homogenised decision support data. In addition, it is foreseen that at least some of these data preparation methods (whether applied to the query, the decision support element data or both) may be performed using a trained AI approach to optimise the large data volumes efficiently.

By performing such data preparation ahead of evaluating the query, the present method can substantially mitigate the difficulty of comparing the query definition against the extremely large volume of non-homogenous data that makes up the decision support elements. In other words, without such data preparation steps the method specific implementations may have to be limited to a far more restricted set of data making up the decision support elements, and/or the data making up the decision support elements may need to be curated and/or indexed so as to cause the data to be more homogenous ahead of the query evaluation. The present approaches do not exclude the use of a restricted data set or a curated/indexed/homogenised data set, rather in such examples the effort of the data preparation is replaced by the effort required to pre-process the data before query evaluation. In some implementations, it may be appropriate to implement a mixture of the data preparation step S3-3 and a separate pre-processing of the data making up the decision support elements

Thus the present approaches permit the evaluation of a query that specifies a contaminant, a food in which there is concern that the contaminant might appear, and a geography from which the food may originate and/or in which the food is intended to be used/consumed/processed/sold (for brevity all of these uses are generally referred to herein as used and/or consumed). Such a query is evaluated against the one or more large and non-homogenous data sets to determine a risk that the food may contain such a contaminant when sourced from and/or used/consumed in the specified geography. From such a determined risk, one or more responsive actions can be defined so as to permit management of that risk.

Turning again to FIG. 3, at step S3-5 the query is evaluated by query evaluation processing. To process the query, the query data are compared to and evaluated against the input data. The exact algorithm used for any given query varies according to the query and the nature of the decision support element data that is available. For example, if the contaminant has high intrinsic relevance and there is a very high risk that the contaminant is used or to be found in the food environment at the production geography, then the other decision support elements may not be particularly influential and a high risk result can be returned after considering only those decision support elements. However in such a situation it may be relevant still to consider other decision support elements as, for example, the contaminant maximum residue level/maximum limits status and/or the contaminant derived properties may provide useful information as to what actions for managing that risk should be proposed.

It is therefore seen that the approach for evaluating the query is not so much a defined algorithm as a context-dependent decision-making space. As one example, if the contaminant specified in a query is in fact not considered to be a contaminant in the geography under consideration in the query, then the risk may be assessed as being low without reference to other data. In another example the processing may start from a full list of many or all possible contaminants and then remove ones of those contaminants from consideration by comparison to different dimensions specified in the query and the various decision support elements, and this might start with contaminant intrinsic relevance. In a further example, the processing may gradually build from the various input data of the decision support elements only the content relevant to the specific dimension values. It is seen that different approaches may be applicable to different dimension values, for instance for contaminants of a particular level 2 or level 3 definition type (c.f. FIG. 2 for example) it may be appropriate to start with all contaminants and exclude ones of the contaminants as the data is reviewed, whereas for other definition types the opposite may hold true. Once the query(s) is processed, the output will indicate a certain level of risk that, for the specified query dimensions, one or more contaminants specified in the contaminant dimension needs to be considered as a potential problem. This risk may be expressed as a binary yes/no type risk presence, or a more graduated risk such as a low/medium/high, or an even more graduated risk such as a numerical scale or a percentage.

Thus, at an overall level, the values of properties are combined to derive the risk of contaminants of being linked to food-related issues as well as potential management actions. This approach will operate including use of any closely-related compounds and/or a common denominator for the contaminant where such has been defined.

As an example, if the pesticide Dichlorvos is registered to be used in New-Zealand for kiwi cultivation and is being detected in kiwis from New-Zealand, and if these kiwis are going to be marketed in Switzerland where Dichlorvos is not authorized and thus the Maximum Residue Levels for dichlorvos in kiwi in the Swiss market is lower that the levels set in New-Zealand, one possible outcome of the algorithm could be: risk of dichlorvos present in kiwis from New-Zealand and marketed in Switzerland to be linked to food-related issues: high; and (with a view ahead to management action recommendations as in the later steps of the method), a proposed management action could be: analysis of dichlorvos mandatory as food release criteria.

As an example to illustrate how incorrect processing in the query evaluation could lead to incorrect conclusions, consider a situation in which the pesticide Aldicarb is registered to be used in Mexico for grapefruit cultivation. If only its metabolite Aldicarb-sulfone is detected in grapefruits from Mexico, and if these grapefruits are going to be marketed in Switzerland where Aldicarb is not authorized and regulated, the present approach using closely related compounds and/or common denominator processing of the data used in the query evaluation will correctly note that the risk of Aldicarb (sum of aldicarb, its sulfoxide and its sulfone, expressed as aldicarb) being found in such grapefruit is high and a management action will likely be needed. In contrast, consider a hypothetical scenario where these data are considered in an isolated manner. This could permit a determination that, as the pesticide itself is not found in the grapefruit, an incorrect conclusion such as “Aldicarb is used but no residue is found and it is not regulated, thus aldicarb may not be associated to food-related issue”. The present approaches avoid such incorrect conclusions by taking a holistic view on the data, despite the huge volumes and non-homogenous nature of the data, for example by looking at the regulation in respect of the source and destination geographies separately and looking at the contaminant from a closely related compounds and/or common denominator perspective.

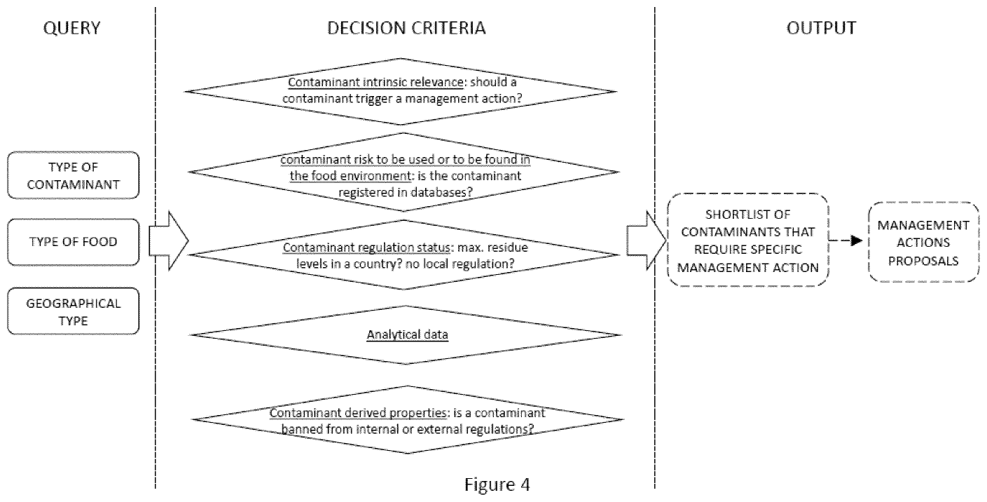

This processing of the query is also illustrated as a high level decision tree in FIG. 4. As shown in this Figure, the query (comprising the three dimensions of type of contaminant, type of food and type of geography as well as any optional further dimensions) is assessed against decision criteria that correspond to the various decision support elements data.

By making this assessment of the query dimensions against the decision criteria corresponding to the decision support elements data, the process provides one or more of a shortlist of contaminants (as specified in the query dimension of one or more queries) that require specific management action, and management action proposals.

As further illustrated in FIG. 3, step S3-7 the evaluation of the query can output a shortlist of contaminants that require specific management action.

This step may be used for example in a situation which a query specifies multiple contaminants, and/or if a batch of queries is submitted at the same or similar times. For instance a query could for example specify “all pesticides” as the contaminant in a situation in which the user has little knowledge of the likely contaminant landscape for a given food.

This step may also be used for example in situations in which a query specifies a single contaminant, but where the use of closely-related-compounds processing and/or common denominator processing in effect expands the query contaminant to include a number of contaminants.

Whatever the risk grading scheme used in a particular implementation, where multiple contaminants are identified that have a risk that would indicate that some form or mitigative or management action may be needed, these can be collated as the shortlist in step S3-7.

Turning to step S3-9, and whether or not there has been a shortlist created at step S3-7, the method continues with the determination of one or more management action proposals that may be provided to a user for mitigating or removing the identified risk. In the present approaches, the management action may be determined based upon the contaminant risk alone, or upon the contaminant risk in combination with some of the properties relating to the query dimensions and/or decision support elements.

For example, if the risk outcome indicates an extremely high or potentially fatal risk, then there may be no need to consider further properties information in order to conclude that an instruction not to use the food specified in the query should be given as the management action (as illustrated at step S3-11). Similarly, if the indicated risk is zero or approximating to zero then there may be no need to use any properties information to indicate that no management action is needed.

In other examples, the properties information may be taken into account in one or more specified management actions. For instance if the risk outcome relates to a moderate risk of a particular pesticide being present, then a surveillance plan to monitor the pesticide presence in a food may be an appropriate management action. Other possible management actions might include an adaptation of an analytical portfolio, triggering an audit for a given source or supplier, or the like (as illustrated at step S3-13).

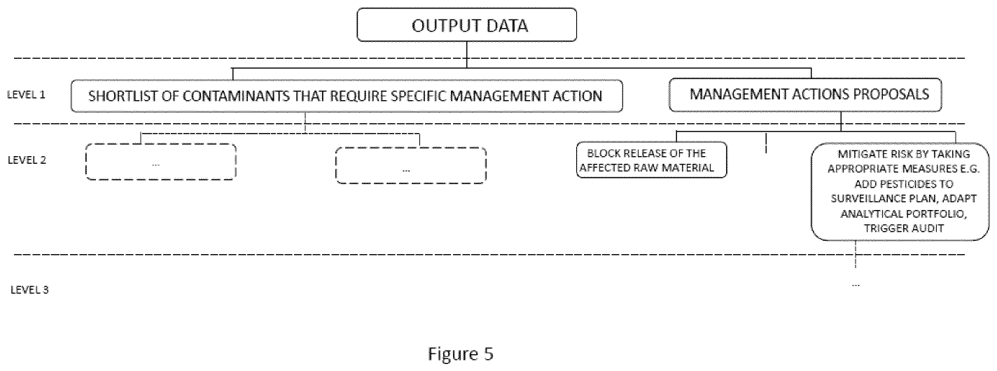

Such example outputs based upon the risk determined by the query evaluation processing are further illustrated in FIG. 5, which indicates a schematic data definition structure for output action definitions as may be used with the present approaches. As illustrated, the definition may consider these data at various levels. For example, within the level 1 output of the management action proposals, these may be divided at a second level between an outright block on release of the food (aligning to step S3-9) and various risk mitigation management actions that can be applied without blocking the food altogether (aligning to step S3-11). As is further indicated by the further spaces and connectors, these may be further defined at further levels as appropriate to any particular implementation.

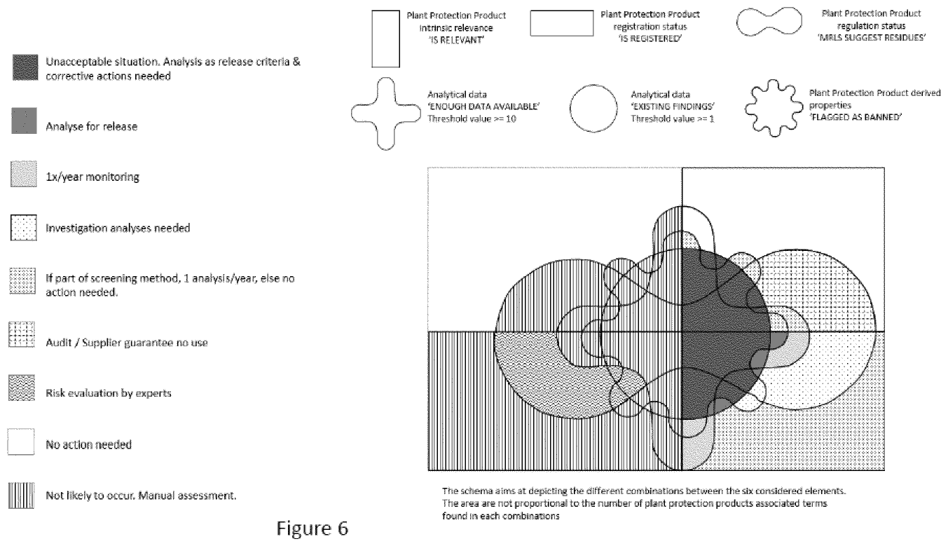

More detail of possible management actions and how they are determined from the risk determined by the query evaluation processing is discussed below with reference to FIG. 6.

In the final illustrated step of FIG. 3 (step S3-15) the method includes validation feedback in relation to successful execution of the management actions. Such validation feedback may be provided through computer-based tracking of the management actions specified and detectable indicators that these have been put in place. In some examples this may take the form of data that may be included as further decision support element data for future evaluations including data describing the acts and/or impacts of the management actions. In some examples this validation feedback may alternatively or additionally be provided by specific data capture relating to the carrying out of the management action. By including such validation feedback the present approaches provide for the system to facilitate the tracking of management action implementation and impact. For example, over the course of handling a number of queries and recommending specific management actions, it may be possible to learn that certain management actions have a higher success rate at preventing food recall events or the like and so the management action determination may be modified over time to learn from these now-historical outcomes.

In some implementations, it may be appropriate to include some form of checking process in relation to the algorithm outcome. For example, it may be that a new algorithm approach is being tested and some form of outcome double check is included as an algorithm validation process. In further examples, such a double check may be applied on an ongoing basis. Such a check may be applied at the algorithm output directly (e.g. between steps S3-5 and S3-7) or in relation to the proposed management actions and/or their validation (e.g. at or after step S3-9 and/or step S3-15).

One example would be to compare the algorithm output to a result determined using a small but representative data set to check whether the outcome is not wholly dissimilar to that expected from the small data set. This small data set could be a subset, or could relate to a parallel or otherwise similar query on different data. A specific example might be that a query is run on contaminants in spices, a query that relies on assessing against a large volume of data. A check may be performed using just one spice as a representative subset, and the process can then be scripted and optionally include generation of intermediate data files so as to be able to check at multiple different stages of the data processing.

Another approach relates to considering the management actions and the validation that would occur once the management actions have been taken. The algorithm can be considered as being correct if, for example, validation shows that expected contaminant are detected via monitoring. Such an approach can be used “live” by performing ongoing monitoring of the algorithm accuracy, but could also be used in a “test” mode in which an algorithm is used to evaluate a query on data for which management action results are already available to use in validating the management action proposals.

Another possible approach is to use the output of the algorithm and/or proposed management actions for a given query to predict regulatory changes in relation to the subject of the query. Then evidence of the algorithm accuracy is found from the regulatory alterations. Again this approach could be used “live” to look for possible future regulatory changes, or it could be used in a “test” mode in which the fact of the regulatory change is specifically withheld from the decision support data and the algorithm then run to see whether it can predict the regulatory change.

Turning now to FIG. 6, this provides a schematic illustration of a management action proposals decision schema. This illustrates an approach that can be taken to utilise the risk determined for the query dimensions, in combination with the data of the decision support elements that were used to process the query, so as to select an appropriate management action. As will be appreciated, references to “management” actions herein are not management in the sense of business management or the like, but rather to preventative or corrective actions and tasks to perform in the interests of maintaining food safety by processing foods in a way that will minimise consumer risk and risk of a product recall or the like being necessary.

The specific schema example illustrated in FIG. 6 is contextualised to plant protection products such as pesticides and the like. The skilled reader will understand that these principles can be applied based on the specific data at hand to any form of contaminant based for any given implementation of the present approaches.

As shown in FIG. 6, various shapes are plotted over one-another to define regions of a decision space with each shape corresponding to a property found in or characterising one or more of the decision support elements. The regions defined by these overlapping shapes in the decision space are then used as boundaries for determining a suitable management action to take, depending on the value of each of the properties that the shape defines.

In this example, the shapes represent the following types of data:

| | |
|---|---|
| [symbol] | represents a vertical division of the decision space into a “left-hand” region in which the plant protection product intrinsic relevance is Not-Relevant and a “right-hand” region in which the plant protection product intrinsic relevance is Relevant |
| [symbol] | represents a horizontal division of the decision space into an “upper” region in which the plant protection product registration |
| | status is Not-Registered and a “lower” region in which the plant |
| | protection product registration status is Registered |
| [symbol] | represents the division of the decision space into an “outer” region in which the plant protection product regulation status is MRLS- |
| | Suggests-No-Residue and an “inner” region in which the plant |
| | protection product regulation status is MRLS-Suggests -Residue |
| [symbol] | represents the division of the decision space into an “outer” region in which the analytical data indicates that against a threshold data presence of >=10 there is Not-Enough-Data-Available and an |
| | “inner” region in which the analytical data relates indicates that |
| | against the same threshold data presence that there is Enough- |
| | Data-Available |
| [symbol] | represents the division of the decision space into an “outer” region in which the analytical data relates indicates that against a |
| | threshold data presence of >=1 there are No-Existing-Findings and |
| | an “inner” region in which the analytical data relates indicates that |
| | against the same threshold data presence that there are Existing- |
| | Findings |
| [symbol] | represents the division of the decision space into an “outer” region in which the plant protection product derived properties are Not- |
| | Flagged-As-Banned and an “inner” region in which the plant |
| | protection product derived properties are Flagged-As-Banned |

As shown the size and relative placement of these shapes in the decision space creates the schema for determining a management action. As noted, the size of each shape and thus the areas defined by their overlaps are not proportional to the number of instances which fall into the combination created by the overlapping shapes. The different management actions specified by the various mappings of this example schema are as follows:

Unacceptable situation. Analysis as release criteria & corrective actions needed.
Analyse for release
Monitor once/year
Investigation analyses needed
If part of screening method, analyse once/year, otherwise no action needed
Audit/Supplier guarantee no use in the food chain
Risk evaluation by experts
No action needed

Not likely to occur. Manual assessment (for example that the combination of factors that would lead to a determination in this region is contradictory or otherwise so unlikely that a manual intervention is appropriate to double-check the outcome and if necessary debug the algorithm approach).

Each of these mappings is illustrated in FIG. 6, and these will not be repeated in full here. However by way of illustration the management action to be applied in the case of the product registration status is Not-Registered, regardless of the intrinsic relevance, and where the data point falls into the “outer” region of each of plant protection product regulation status, analytical data relates data availability threshold, analytical data findings threshold, and derived properties, the management action is: “No Action Needed”.

Also, by way of illustration, where intrinsic relevance is Not-Relevant, all defined regions result in one of “Risk evaluation by experts”, “No action needed”, and “Not likely to occur. Manual assessment”. Likewise, where the intrinsic relevance is Relevant and the derived properties is in the inner region the management actions are either “Unacceptable situation. Analysis as release criteria & corrective actions needed.” or “Monitor once/year”.

As noted above, this schema is provided by way of example, and in practice the schema may need to be determined on a per-implementation or per-group-of-implementations basis.

As will be appreciated, the illustrated schema is represented visually in this illustration, but there need not be an actual plot created in order to determine a suitable management action. Rather the data may be analysed to determine the outcome that would have occurred if the actual data values were plotted onto a visual representation of the decision space according to the schema.

Some examples of specific illustrative situations and outcomes to which the present techniques could be applies include the following:
Finding glyphosate in lentils, even if below Maximum Residue Limits, still may be negatively being perceived and creates a food-related issue. Proposed management action could be sourcing raw materials from a country where glyphosate is not being used and auditing the lentils producers. The validation of adequately performed management action could consist in the acquisition of documents providing fully traceability of the lentils origin and a successfully passed audit from producer side.
Determining the risk of occurrence for veterinary drug residues in dairy raw materials with various countries of origin which allows, as proposal for management actions, the optimization of veterinary drug residues control in dairy supply to avoid food related issues. This may include changing the frequency of analytical tests for supplied dairy material specific to the country of its origin and in specific cases a necessity for investigation of use of veterinary drugs at a primary production. Alternatively, this may include rejecting the batches of raw materials which could results in food related issue, corrective actions driven by producer to improve the situation or an exclusion of the primary producer from raw material suppliers. The validation may leverage the test results (data) obtained with proposed frequency of analytical tests consequently included into algorithm and improving the accuracy of risk of veterinary drug residues occurrence or acquisition of t audits reports summarizing the information on the practices of use of veterinary drugs at primary production.
Defining the risk of occurrence for lead and copper residues in honey with different countries of origin which leads to proposal of management actions to avoid food related issues. Such management actions may include optimization of analytical tests' frequency for those honey contaminants that are dependent on country of its origin or rejection of raw material batches with levels of contaminants which could lead to food related issue. The validation may leverage the test results (data) obtained with proposed frequency of analytical tests consequently including them into the algorithm and improving the accuracy of contaminant occurrence determination.
Predicting/Extrapolating the risk of occurrence for veterinary drug residues and pesticides in beef products originating from a specific country, from which products were never previously supplied. This may lead to proposal of management actions to establish the frequency of control for the investigated substances or rejection raw material batches with levels of contaminants which could lead to food related issue. The validation may include leveraging the test results (data) obtained with proposed frequency of analytical tests and consequently include them into algorithm and improve the accuracy of contaminant occurrence determination.

Thus, there have been described various approaches in which large volumes of non-homogenous data can be analysed to determine a risk that one or more types of contaminant will be present in a type of food from and/or for a particular type of geography. These approaches enable the large volumes of data to be used effectively to determine, based on the risk and the particular data used in evaluating the contaminant, one or specific management actions that should be used to enhance food safety and/or reduce a risk of a food product recall event being needed.

As will be appreciated, in that the present approaches are described in the context of computer implementation (which may be referred to as “in-silico”), there may be provided a computer program product that includes instructions executable to cause a programmable computer to carry out the method. Such instructions may correspond to the operating instructions of the computer unit 2 mentioned with reference to FIG. 1 above. Such a computer program product may be provided by way of a computer-readable medium. A computer-readable medium may be a storage medium and/or a transmission medium. Computer-readable storage media can include magnetic, optical and/or electronic data storage media, and can be portable (such as a CD, DVD, floppy disk, usb memory stick, memory card or the like) or intended to be installed within a computer system (such as a hard disk drive, SSD or the like) and may generally be termed a “non-transitory” computer-readable medium. A transmission medium can occur for carrying instructions between components of a computer system (such as on a bus, cable or other interconnect) and/or between multiple separate computer systems (such as over a wired or wireless network, an access network, a point-to-point cable or the like), and can include a carrier wave, transmission signal or similar.

From one perspective there has been described a system and method for predicting risks associated with the presence of contaminants in a food. The method can comprise receiving a query defining a food, a geography and a contaminant. The method can then determine a risk that the food contains the contaminant in relation to the geography. The method also comprises providing a response to the query comprising one or more recommended management actions in relation to the determined risk.

It should be understood that various changes and modifications to the described examples for implementing the present approaches as described herein will be apparent to those skilled in the art. Such changes and modifications can be made without departing from the spirit and scope of the present invention and without diminishing its attendant advantages. It is therefore intended that such changes and modifications be covered by the appended claims.

Further examples of the present teachings are set out in the following numbered clauses:

Clause 1. A method for predicting risks associated with the presence of contaminants in a food or feed product, the method comprising: receiving a query defining a food or feed, a geography and a contaminant; determining a risk that the food or feed contains the contaminant in relation to the geography; and providing a response to the query comprising one or more specified management actions in relation to the determined risk.

Clause 2. The method of clause 1, wherein the response further comprises the determined risk.

Clause 3. The method of clause 1 or 2, further comprising obtaining from a data store one or more property data describing properties of at least one of the food or feed, the geography and the contaminant, wherein the determining comprises utilising the one or more property data to determine the risk.

Clause 4. The method of clause 3, wherein the property data comprises data describing a risk that the contaminant is likely to be found in a food or feed originating from the geography.

Clause 5. The method of clause 3 or 4, wherein the property data comprises data describing an intrinsic relevance of the contaminant as a problematic constituent of a food or feed.

Clause 6. The method of clause 3, 4 or 5, wherein the property data comprises data describing the existence of analytical data related to one or more of the food or feed, the geography and the contaminant.

Clause 7. The method of any of clauses 3 to 6, wherein the property data comprises data describing a regulatory limit or threshold for the contaminant in a food or feed.

Clause 8. The method of any of clauses 3 to 7, wherein the property data comprises derived properties of the contaminant.

Clause 9. The method of any of clauses 3 to 8, wherein the property data comprises data from a plurality of different sources, and wherein the method compares data from a first source to data from a second source using a mapping scheme and/or a data term synonym protocol.

Clause 10. The method of any preceding clause, wherein a contaminant comprises a substance that may be comprised within a food or feed, which substance is potentially harmful upon consumption of the food or feed by a human or animal.

Clause 11. The method of clause 10, wherein the determining includes considering the contaminant and closely related compounds to the contaminant.

Clause 12. The method of any preceding clause, wherein a geography is a geographic and/or geopolitical region in which a food or feed is grown, harvested, processed and/or manufactured.

Clause 13. The method of any preceding clause, wherein a food or feed is a substance which is intended to an edible product and/or is to be used as an ingredient for an edible product.

Clause 14. The method of any preceding clause, wherein the recommended management actions comprise instruction to block release of the food or feed, permit release of the food or feed and/or conduct a mitigative action in relation to sourcing or production of the food or feed.

Clause 15. The method of any preceding clause, further comprising, after receiving the query, performing one or more of: data format conversion; nomenclature processing; common denominator processing; and language processing one or more of the food or feed, the geography and the contaminant.

Clause 16. The method of clause 15, wherein the data format conversion comprises adapting the query to one or more data formats required for the determining.

Clause 17. The method of clause 15 or 16, wherein the nomenclature processing comprises one or more of synonym processing and/or closely-related-data processing.

Clause 18. The method of clause 17, wherein the synonym processing comprises expanding the query to include synonyms of food or feed, the geography and the contaminant.

Clause 19. The method of clause 17 or 18, wherein the closely-related-data processing comprises expanding the query to include closely related compounds to the contaminant, such as salts, esters, metabolites, degradation products, and complex residue definitions for that contaminant Clause 20. The method of any of clauses 15 to 19, wherein the language processing comprises expanding the query to include translations into another language of at least one of the food or feed, the geography and the contaminant.

Clause 21. The method of clause 3 or any clause dependent thereon, wherein the property data comprises non-homogenous data from a plurality of data sources.

Clause 22. The method of clause 3 or any clause dependent thereon, wherein the property data comprises at least 1 million data points.

Clause 23. The method of any preceding clause, further comprising outputting a shortlist of contaminants that require specific management action.

Clause 24. The method of any preceding clause, further comprising validating performance of one or more of the one or more specified management actions.

Clause 25. A system for predicting risks associated with the presence of contaminants in a food or feed, the system comprising a programmable computer unit configured to carry out the method of any preceding claim.

Clause 26. A computer readable medium carrying instruction that when executed by a programmable computer cause the programmable computer to become configured to carry out the method of any of clauses 1 to 24.

Clause 27. A method for predicting risks associated to the presence of contaminants in a food or feed, wherein said method comprises the steps of:
(i) providing a set of input data from local or network/internet databases, said data comprising: a type of contaminant associated to a raw material, a type of geography, and a type of food or feed,
(ii) assessing the risk associated to the presence of said contaminant in said food or feed, in relation to the type of geography,
(iii) providing a level of risk associated to said contaminant, and
(iv) providing a set of recommended actions in relation to said risk.

Clause 28. A method according to claim 27, wherein the type of contaminant comprises pesticides, veterinary drugs, man-made environmental contaminants, or molecules naturally present in the environment.

Clause 29. A method according to clause 28, wherein pesticides comprise chemical or bio-based pesticides.

Clause 30. A method according to clause 28, wherein molecules are man-made environmental contaminants such polyaromatic hydrocarbons or other incineration or recycling by-products.

Clause 31. A method according to clause 28, wherein molecules naturally present in the environment comprise heavy metals or microorganisms.

Clause 32. A method according to any of clauses 27 to 31 wherein the type of geography comprises a crop production country and/or a country of sale for the food.

Clause 33. A method according to any of clauses 27 to 32, wherein the type of food comprises a fruit, a vegetable, or an animal-based ingredient.

Clause 34. A method according to any of clauses 27 to 33, wherein the set of recommended actions comprises either: blocking the use of the raw material associated to said contaminant, or mitigating the risk by adding the contaminant to an automated surveillance plan, and/or adapting an analytical portfolio, and/or triggering an audit.

1. A computer-implemented method for predicting and managing risks associated with the presence of contaminants in a food or feed product, the method comprising:
providing at least one ingredient present in said food or feed product from a user query, and at least one marketing country for the product,
obtaining a geographic origin for said at least one ingredient,
calculating a risk score that the food or feed contains a contaminant in relation to said ingredient present in the food or feed product and their respective geographical origin, said calculation being based on the combination of at least one query data selected from the group consisting of: type of contaminant, type of food or feed, type of geography, with at least one input data selected within the list of contaminant intrinsic relevance, contaminant likelihood to be used or to be found in the food environment, contaminant maximum residue level, contaminant maximum limits status, analytical data, and contaminant derived properties,
and
providing a response to the query comprising one or more specified management actions in relation to the determined risk score, as follows:
if the score corresponds to no risk identified, the management action corresponds to an authorization to integrate the ingredient in the food or feed product, or
if the score corresponds to a risk identified that requires the ingredient not to be used, the management action corresponds to a recommendation to take at least one action within the following choices:
source the ingredient from a different supplier,
conduct further detection tests to verify the presence or absence of the identified contaminant in a specific ingredient batch,
modify the ingredient and/or food or feed product production process to eliminate the identified contaminant,
reject the ingredient from the food or feed ingredients list.

2. The method of claim 1, further comprising obtaining from a data store one or more property data describing properties of at least one of the food or feed, the geography and the contaminant, wherein the determining comprises utilising the one or more property data to determine the risk.

3. The method of claim 2, wherein the property data comprises data describing an intrinsic relevance of the contaminant as a problematic constituent of a food or feed.

4. The method of claim 2, wherein the property data comprises data describing the existence of analytical data related to one or more of the food or feed, the geography and the contaminant.

5. The method of claim 2, wherein the property data comprises derived properties of the contaminant.

6. The method of claim 2, wherein the property data comprises data from a plurality of different sources, and wherein the method compares data from a first source to data from a second source using a mapping scheme and/or a data term synonym protocol.

7. The method of claim 1, wherein a contaminant comprises a substance that may be comprised within a food or feed, which substance is potentially harmful upon consumption of the food or feed by a human or animal, for example wherein the determining includes considering the contaminant and closely related compounds to the contaminant.

8. The method of claim 1, wherein the recommended management actions comprise instruction to block release of the food or feed, permit release of the food or feed and/or conduct a mitigative action in relation to sourcing or production of the food or feed.

9. The method of claim 1, further comprising, after receiving the query, performing one or more of: data format conversion; nomenclature processing; common denominator processing; and language processing one or more of the food or feed, the geography and the contaminant.

10. The method of claim 9, wherein the data format conversion comprises adapting the query to one or more data formats required for the determining.

11. The method of claim 9, wherein the nomenclature processing comprises one or more of:
synonym processing; and/or
closely-related-data processing.

12. The method of claim 2, wherein the property data comprises non-homogenous data from a plurality of data sources, and comprises at least 1 million data points.

13. The method of claim 1, further comprising validating performance of one or more of the one or more specified management actions.

14. A system for predicting risks associated with the presence of contaminants in a food or feed, the system comprising a programmable computer unit configured to carry out the method for predicting and managing risks associated with the presence of contaminants in a food or feed product, the method comprising:
providing at least one ingredient present in said food or feed product from a user query, and at least one marketing country for the product,
obtaining a geographic origin for said at least one ingredient,
calculating a risk score that the food or feed contains a contaminant in relation to said ingredient present in the food or feed product and their respective geographical origin, said calculation being based on the combination of at least one query data selected from the group consisting of: type of contaminant, type of food or feed, type of geography, with at least one input data selected within the list of contaminant intrinsic relevance, contaminant likelihood to be used or to be found in the food environment, contaminant maximum residue level, contaminant maximum limits status, analytical data, and contaminant derived properties,
and
providing a response to the query comprising one or more specified management actions in relation to the determined risk score, as follows:
if the score corresponds to no risk identified, the management action corresponds to an authorization to integrate the ingredient in the food or feed product, or
if the score corresponds to a risk identified that requires the ingredient not to be used, the management action corresponds to a recommendation to take at least one action within the following choices:
source the ingredient from a different supplier,
conduct further detection tests to verify the presence or absence of the identified contaminant in a specific ingredient batch,
modify the ingredient and/or food or feed product production process to eliminate the identified contaminant,
reject the ingredient from the food or feed ingredients list.

15. A computer readable medium carrying instruction that when executed by a programmable computer cause the programmable computer to become configured to carry out the method for predicting and managing risks associated with the presence of contaminants in a food or feed product, the method comprising:
providing at least one ingredient present in said food or feed product from a user query, and at least one marketing country for the product,
obtaining a geographic origin for said at least one ingredient,
calculating a risk score that the food or feed contains a contaminant in relation to said ingredient present in the food or feed product and their respective geographical origin, said calculation being based on the combination of at least one query data selected from the group consisting of: type of contaminant, type of food or feed, type of geography, with at least one input data selected within the list of contaminant intrinsic relevance, contaminant likelihood to be used or to be found in the food environment, contaminant maximum residue level, contaminant maximum limits status, analytical data, and contaminant derived properties,
and
providing a response to the query comprising one or more specified management actions in relation to the determined risk score, as follows:
if the score corresponds to no risk identified, the management action corresponds to an authorization to integrate the ingredient in the food or feed product, or
if the score corresponds to a risk identified that requires the ingredient not to be used, the management action corresponds to a recommendation to take at least one action within the following choices:
source the ingredient from a different supplier,
conduct further detection tests to verify the presence or absence of the identified contaminant in a specific ingredient batch,
modify the ingredient and/or food or feed product production process to eliminate the identified contaminant,
reject the ingredient from the food or feed ingredients list.
